(19) United States
(12) Patent Application Publication
(10) Pub. No.: US 2026/0338921 A1
(43) Pub. Date: Oct. 29, 2026

(54) Optoelectronic receiver, optoelectronic sensor, use and method for distance measurement by means of time-of-flight method

(71) Applicant: SICK AG, Waldkirch (DE)

(72) Inventors: Alexander HERBSTRITT, Freiburg (DE); Ino GEISEMEYER, Freiburg (DE)

(21) Appl. No.: 19/630,815

(22) Filed: Mar. 27, 2026

(30) Foreign Application Priority Data
Apr. 24, 2025 (DE) 102025115864.9

(51) Int. Cl. G01S 7/481; G01S 7/4865; G01S 7/497; G01S 17/10

(52) U.S. Cl. CPC G01S 7/4816; G01S 7/4865; G01S 7/497; G01S 17/10

(57) ABSTRACT

The invention relates to an optoelectronic receiver, in particular for distance measurement by means of time-of-flight methods, comprising at least one signal generator for generating at least one diagnostic signal; a pixel array having at least one reception pixel, in particular a differential reception pixel, and at least one reference pixel, wherein the pixel array is configured to generate and output a reception signal based on reception light received by means of the reception pixel and/or to generate and output a reference signal by reading out the reference pixel.

The invention relates to an optoelectronic receiver, an optoelectronic sensor, a use and a method, in particular for distance measurement by means of time-of-flight methods.

In conventional optoelectronic receivers and optoelectronic sensors, components are often provided redundantly to enable as reliable as possible an operation of the optoelectronic receiver or the sensor. In this respect, the terms safe or safety used herein can be understood within the meaning of certain safety-specific standards, such as IEC 61508, ISO 13849 or IEC 62998. However, redundancy (i.e. the use of two optoelectronic receivers or redundant structures within the receiver) can bring about disadvantages such as a larger chip size, a larger device size, a higher power consumption, a longer processing time and/or higher costs.

The monitoring or testing of components of an optoelectronic receiver, ideally during its operation, can increase the performance of the optoelectronic receiver, in particular with respect to its functional safety. In particular, it may be beneficial or necessary for safety-oriented applications to achieve a certain degree of diagnostic coverage by implementing functional tests. In other words, certain internal errors should be recognized as reliably as possible by suitable functional tests. This can be of particular importance if components of the optoelectronic receiver are not present in redundant form.

The invention is based on the object of improving the efficiency and performance of an optoelectronic receiver, in particular with respect to its functional safety.

An optoelectronic receiver having the features of claim 1 is provided to satisfy the object.

The optoelectronic receiver according to the invention, in particular for distance measurement by means of time-of-flight methods, comprises at least one signal generator for generating at least one diagnostic signal and a pixel array having at least one reception pixel, in particular a differential reception pixel and at least one reference pixel, in particular a differential reference pixel, wherein the pixel array is configured to generate and output a reception signal based on reception light received by means of the reception pixel and/or to generate and output a reference signal by reading out the reference pixel. The optoelectronic receiver further comprises at least one processing unit for signal processing and at least one connection unit that is connected to the pixel array, the signal generator and the processing unit and that is configured to selectively couple the pixel array or the signal generator to the processing unit so that selectively the reception signal and/or the reference signal, on the one hand, or the diagnostic signal, on the other hand, can be fed into the processing unit for signal processing. The connection unit is configured to couple the signal generator to the processing unit at (pre)determined intervals in order to feed the diagnostic signal into the processing unit for signal processing for a first functional test, in particular for the recording of diagnostic data.

Preferably, the connection unit is configured, for the first functional test, to couple the at least one signal generator to the processing unit (at predetermined points in time) during, in particular at the end of, each illumination phase of the distance measurement and/or between each illumination phase of the distance measurement. Preferably, the connection unit is configured, for the first functional test, to couple the at least one signal generator to the processing unit at the same recording rate as the distance measurement.

In other words, the invention is based on the idea of providing a connection unit in the optoelectronic receiver or using an existing connection unit by means of which selectively a coupling between the processing unit and the pixel array or between the processing unit and the at least one signal generator can be established. In other words, by means of the connection unit, the reception signal and/or the reference signal can be replaced with the diagnostic signal for the subsequent signal processing, in particular in response to a control signal of a control, for a (first) functional test that is independent of external influences. Furthermore, the possibility is provided of implementing further (or alternative) functional tests by means of the at least one reference pixel. This/these approach(es) can allow errors in the optoelectronic receiver, and in particular in the processing unit and also in further components, e.g. in a downstream downstream data preprocessing unit (which is optional), to be recognized during the operation of the optoelectronic receiver and the functional safety of the optoelectronic receiver to be improved without redundant hardware structures having to be provided. For example, a warning signal can be output in response to the recognition of an error. This implementation of the optoelectronic receiver can be more efficient in terms of (additional) circuits, the power consumption, the software requirements, the processing time and more. Overall, the efficiency and/or performance of the optoelectronic receiver can thus be increased, in particular with respect to its functional safety. Preferably, the use of (conventional) optoelectronic receivers can be enabled for safety applications.

A plurality of data sets of diagnostic data are preferably recorded for the first functional test between or during each illumination phase of the distance measurement. Preferably, the at least one signal generator is configured to use different settings for each recording of a data set of diagnostic data. For example, the amplitude of the diagnostic signal can be varied for the start and/or the end of a diagnostic run-through, in particular selected in an application-specific manner.

The at least one reception pixel can preferably be a differential reception pixel. In other words, it can be achieved that an optoelectronic receiver comprising at least one differential reception pixel can be tested for its operational reliability during its operation.

The (differential) reception pixel can, for example, comprise at least two storage elements (i.e. charge store, charge well) that can be controlled temporally separately from one another and that can collect and store reception light (e.g. as electrical charge) with a time offset depending on the phase of the distance measurement. The storage elements can comprise capacitors. The point in time of the transmission of the transmission light and the points in time of the control of the storage elements can be temporally coordinated with one another. The time offset can be taught and can be corrected at a later point in time in the processing chain to enable a more accurate measurement. The storage elements can then be read out, simultaneously or with a time offset, to generate the (differential) reception signal. This design of the reception pixel can make it possible to reduce the susceptibility of the optoelectronic receiver with respect to environmental light, to reduce noise in the distance measurement and to improve the dynamic range of the optoelectronic receiver.

For example, the at least one (differential) reception pixel can comprise a first and second storage element. The first storage element can be configured to collect and store reception light as electrical charge (i.e. the charge amount corresponding to the reflected or remitted pulses of the transmission light) for the duration of each transmitted pulse of the transmission light, i.e. from the point in time of the transmission of the transmission light up to the point in time of the end of transmission of the transmission light. The second storage element can be configured to collect and store reception light from the point in time of the end of the transmission of the transmission light up to the point in time of the transmission of a subsequent pulse of the transmission light. The first signal component of the reception signal can then be generated by reading out the first storage element and the second signal component of the reception signal can be generated by reading out the second storage element. The first and/or the second signal component of the reception signal can optionally be temporarily stored in an (analog) memory and can then be output together.

The recording rate of the distance measurement can be in a range from 10 Hz to 100 Hz. A plurality of individual measurements, e.g. nine individual measurements, can be combined for the distance measurement. For example, at a recording rate of 30 Hz, a total of 30*9=270 individual measurements are performed per second. For example, transmission light can be transmitted in a modulated manner, i.e. a plurality of pulses of the transmission light can be transmitted for each individual measurement. The illumination phase of the distance measurement can include all the processes that, taken together, are necessary to generate the measurement values that in particular result in a measured distance value.

The diagnostic signal can be a current signal or a voltage signal. Accordingly, the signal generator can be a current generator or a voltage generator. Preferably, the signal generator comprises a (programmable) voltage generator for generating a variable voltage signal. The signal generator can comprise a digital-to-analog converter (DAC).

The optoelectronic receiver can receive transmission light reflected or remitted (i.e. diffusely reflected) by a detection zone (in particular by objects in the detection zone) as reception light and can generate the reception signal based on the received reception light by means of the at least one reception pixel. The reception signal can in this respect be a differential reception signal that comprises a first signal component and a second signal component that are output via their own output in each case and/or are transmitted via separate lines.

The transmission light can be generated by a light transmitter coupled to and/or controlled by the optoelectronic receiver and can be transmitted into the detection zone.

The optoelectronic receiver can, for example, comprise a control, such as a microprocessor, a programmable state machine or a field programmable gate array (FPGA), which is configured to control the optoelectronic receiver, and in particular the connection unit, and preferably also other devices, such as a light transmitter and/or at least one reference illumination unit, in order to perform the first functional test (and/or also other functional tests). The control can, for example, be pre-installed in the optoelectronic receiver to control general functions of the pixel array and/or the processing unit (and/or also other devices, such as a light transmitter and/or a reference illumination unit). In other words, an already existing control that is typically used for other purposes can be reused for the implementation of the first functional test (and/or other functional tests) of the optoelectronic receiver so that no additional control needs to be provided for implementing the first functional test (and/or other functional tests).

A plurality of signal generators, i.e., for example two, three, four or more signal generators, can also be present in the optoelectronic receiver. For example, in each case at least one signal generator can be provided for each column and/or row of the pixel array. Each of the signal generators can be programmed differently and can output a different diagnostic signal, for example.

According to one embodiment, the at least one reference pixel comprises at least one dark pixel, wherein the pixel array is configured, for a second functional test, in particular for the recording of dark signal data, to generate and output a dark signal by reading out the dark pixel, and wherein the connection unit is configured to couple the pixel array to the processing unit at pre(determined) time intervals in order to feed the dark signal into the processing unit for signal processing for the second functional test, in particular for the recording of the dark signal data. In other words, the reference signal can comprise the dark signal; in particular, the reference signal can be the dark signal. The connection unit is preferably configured, for the second functional test, to couple the pixel array to the processing unit (at predetermined points in time) during each illumination phase of the distance measurement and/or between each illumination phase of the distance measurement. The connection unit is preferably configured, for the second functional test, to couple the pixel array to the processing unit at the same recording rate as the distance measurement. The dark pixel can, for example, be a pixel that lies outside an illumination zone and/or that is covered by a metallization layer. Alternatively, it can, for example, be a reception pixel that is less sensitive to the reception of reception light. The reduced sensitivity can, for example, be achieved by a mechanical cover, an aperture, at least one optical filter, a restriction of the illumination zone via the lens design and/or by the control of the pixel (e.g. via a reduced integration time, a change in the quantum efficiency or the readout efficiency, a variation in the supply voltage or other). The dark signal can be a (temperature-dependent) signal with a very low signal amplitude, in particular with a signal amplitude close to zero, that provides a reference point that is ideally largely independent of external influences. A plurality of data sets of dark signal data are preferably recorded for the second functional test between or during each illumination phase of the distance measurement. The pixel array is preferably configured to use different settings, in particular different integration times for the reading out of the dark pixel, for each recording of a data set of dark signal data. By means of this second functional test, errors in the optoelectronic receiver, and in particular both in the pixel array and in downstream components, such as the connection unit, the processing unit and/or an (optional) data preprocessing unit, can be recognized during the operation of the optoelectronic receiver and the functional safety of the optoelectronic receiver can be further improved. The at least one dark pixel can be largely shielded from external influences (e.g. transmission light from other sensors and/or environmental light) during the second functional test. It can therefore be checked by the second functional test whether the optoelectronic receiver is functional when external influences are largely excluded.

According to a further embodiment, the at least one reference pixel comprises at least one reference reception pixel that receives reference light and/or separates the at least one reception pixel and at least one dark pixel of the pixel array from one another, wherein the pixel array is configured, for a third functional test, in particular for the recording of first reference data, to generate and output a first reference signal by reading out the reference reception pixel, wherein the connection unit is configured to couple the pixel array to the processing unit at (pre)determined time intervals in order to feed the first reference signal into the processing unit for signal processing for the third functional test, in particular for the recording of the first reference data. In other words, the reference signal can comprise the first reference signal; in particular, the reference signal can be the first reference signal. The connection unit is preferably configured, for the third functional test, to couple the pixel array to the processing unit (at predetermined points in time) during each illumination phase of the distance measurement and/or between each illumination phase of the distance measurement. The connection unit is preferably configured, for the third functional test, to couple the pixel array to the processing unit at the same recording rate as the distance measurement. The at least one reference reception pixel can, for example, be a pixel that is arranged between the at least one reception pixel and the dark pixel. In this respect, the reference reception pixel can also be referred to as a “buffer pixel”, for example. The reference reception pixel can advantageously separate the at least one reception pixel and the at least one dark pixel from one another in order, for example, to reduce or avoid mutual interference (crosstalk) between the at least one reception pixel and the at least one dark pixel. The reference reception pixel can be unusable for receiving reception light and for generating the reception signal, but can still be usable for the second functional test. Additionally or alternatively, the reference reception pixel can be configured to receive reference light focused (only) on the region of the reference reception pixel for the generation of the first reference signal. The reference light can e.g. be generated by a reference illumination unit provided for this purpose or can be supplied to the reference reception pixel by a reference light optics. The first reference signal can, for example, have a signal amplitude of greater than zero. The signal amplitude of the first reference signal can be greater than the signal amplitude of the dark signal. A plurality of data sets of first reference data are preferably recorded for the third functional test between or during each illumination phase of the distance measurement.

The pixel array is preferably configured to use different settings for each recording of a data set of first reference data, in particular different illumination times for the reference reception pixel and/or different integration times for the reading out of the reference reception pixel. The optoelectronic receiver can likewise be configured to use different settings for each recording of a data set of first reference data, in particular different frequencies for the reference light and/or different phase positions between the reference light and the reference reception pixel. By means of this third functional test, errors in the optoelectronic receiver, and in particular both in the pixel array and in downstream components, such as the connection unit, the processing unit and/or an (optional) data preprocessing unit, can be recognized during the operation of the optoelectronic receiver and the functional safety of the optoelectronic receiver can be further improved. The at least one reference reception pixel can possibly also be affected by external influences (e.g. transmission light from other sensors and/or environmental light) during the third functional test. It can therefore be checked by the third functional test whether the optoelectronic receiver is also functional under external influences.

It is understood that the first, second and third functional test can also be implemented in any combination in the optoelectronic receiver. For example, the second and/or third functional test can be implemented in the optoelectronic receiver instead of the first functional test. Advantageously, the combination of a plurality of the functional tests, in particular of all the functional tests, can allow the optoelectronic receiver, in particular the pixel array, the connection unit, the processing unit and/or an (optional) data preprocessing unit, to be tested over the entire dynamic range and, as a result, the safety of the optoelectronic receiver to be improved even further.

According to a further embodiment, the components of the optoelectronic receiver, in particular the signal generator, are configured and/or pre-installed for a calibration, and in particular an initial calibration, of the optoelectronic receiver. In this way, the components of the optoelectronic receiver can be used for several purposes and thus more efficiently. At the same time, additional hardware structures that would, for example, have been necessary for providing the diagnostic signal can be saved. Thus, the efficiency and/or performance of the optoelectronic receiver can be increased overall, in particular with respect to its functional safety. Preferably, the usability of a conventional receiver for safety applications can be achieved.

According to a further embodiment, the diagnostic signal is static or variable.

According to a further embodiment, the signal generator is configured to change the amplitude of the diagnostic signal during a diagnostic run-through (i.e. a so-called “sweep”). The first functional test can thus comprise the diagnostic run-through; in particular, the first functional test can be the diagnostic run-through. In this way, the optoelectronic receiver, and in particular the processing unit, can be tested in one diagnostic run-through over the entire dynamic range of the optoelectronic receiver, which can increase the degree of diagnostic coverage. In particular, different components and complex functions of the processing unit can be checked and/or monitored in a simple and flexible manner. For example, single-ended saturation comparators (if present), an (analog) correlated double sampling (CDS) function of an amplifier and its circuits, gain selection comparators, different gain settings of the amplifier, and an analog-to-digital converter (ADC) can be checked and/or monitored over the entire dynamic range up to saturation.

According to a further embodiment, the signal generator is configured to test the entire dynamic range of the optoelectronic receiver in the diagnostic run-through, preferably including single-ended saturation and/or saturation of an analog-to-digital conversion, i.e. ADC saturation. Single-ended saturation can mean that the amplitude of the diagnostic signal corresponds to a saturation of a storage element of the reception pixel.

According to a further embodiment, the signal generator is configured to use different slopes for changing the amplitude of the diagnostic signal during the diagnostic run-through. The slope, which can also refer to an increment, can be selected in dependence on the gain setting of an amplifier of the processing unit or vice versa. The use of different slopes or different increments can allow a denser sampling to be provided for weak signals (and e.g. a higher signal amplification) and, at the same time, a wide dynamic range for stronger signals (and e.g. a lower signal amplification). In other words, a higher number of sampling points can be achieved within a certain signal range. Furthermore, an application-specific diagnosis of the optoelectronic receiver can be enabled.

According to a further embodiment, test data generated during a monitoring of at least one other component of the optoelectronic receiver are replaced with the diagnostic data. For example, the other component can be an amplifier. Due to the (known) diagnostic data, it can be known which data the amplifier should output so that the amplifier can be checked in this way. As a result, the output and/or further processing of the data generated by the optoelectronic receiver can be more reliable.

According to a further embodiment, the diagnostic data and the dark signal data, the first reference data and/or real measurement data are merged into at least one combined output image. It is likewise conceivable that, if applicable, the plurality of data sets of diagnostic data and the plurality of data sets of dark signal data, the plurality of data sets of first reference data and/or real measurement data can also be merged into at least one combined output image.

According to a further embodiment, a plurality of combined output images (e.g. a stack of output images) are generated (and output) during the diagnostic run-through. For example, when generating the plurality of combined output images, different starting points and/or end points and/or different increments of the fed-in diagnostic signal can be considered and a better coverage of the input/output signal and/or a more application-specific coverage can thereby be achieved.

According to a further embodiment, diagnostic data recorded during the diagnostic run-through are added piece-wise to the real measurement data to generate (and output) the plurality of combined output images. By generating a plurality of output images, the further processing of the output images can be facilitated, in particular a step-wise further processing can be realized.

The further processing or analysis of the diagnostic data in the output images by a downstream processor, FPGA and/or SoC, i.e., for example, the data processing unit mentioned here, can thereby start at an early stage and can at least partly already take place while the data processing unit still anyway has to wait for the remaining output images and thus for the complete measurement data set. Once the complete measurement data set has been received, the depth map can be calculated from the raw data. The computing load and, if applicable, a usage of the memory bandwidth by the data processing unit is thereby better distributed over time and the evaluation of the diagnostic data does not reduce the available computing power for e.g. the creation of the depth map by the data processing unit.

One advantage of generating combined output images is that the total required time that the optoelectronic receiver is active, e.g. for each distance measurement or per frame, and thus consumes power, can be reduced since an additional time expenditure for preparing and/or starting the image recording of the diagnostic image is omitted since only the output image for the real measurement data (live measurement data image) is enlarged, e.g. by additional rows of diagnostic data. This time offset can therefore be omitted.

According to a further embodiment, the pixel array comprises a first output (for example an output terminal) for the output of a first signal component of the reception signal and a second output (separate from the first output) for the output of a second signal component of the reception signal, wherein a first input of the connection unit is connected to the first output of the pixel array and a second input of the connection unit is connected to the second output of the pixel array. In particular, the first input of the connection unit can be connected to the first output of the pixel array and the second input of the connection unit can be connected to the second output of the pixel array, directly or indirectly, such that the first signal component and the second signal component of the reception signal can be fed into the connection unit and consequently into the processing unit.

According to a further embodiment, the optoelectronic receiver comprises a first signal generator for generating a first diagnostic signal and a second signal generator for generating a second diagnostic signal, wherein the connection unit is connected to the first output of the pixel array, the second output of the pixel array, the first signal generator, the second signal generator, a first input of the processing unit and a second input of the processing unit and is configured to selectively couple the first and second output of the pixel array to the first and second input of the processing unit or to couple the first and second signal generator to the first and second input of the processing unit. As a result, the first and second signal component of the reception signal (and/or the reference signal), on the one hand, or the first and second diagnostic signal, on the other hand, can be selectively fed into the processing unit for signal processing.

It is understood that the connection unit can be configured to couple the first signal generator to the first input of the processing unit and the second signal generator to the second input of the processing unit at predetermined time intervals for the first functional test, in particular for the recording of the diagnostic data. A first output of the connection unit can be connected to the first input of the processing unit and a second output (separate from the first output) of the connection unit can be connected to the second input of the processing unit.

Preferably, the first diagnostic signal is different from the second diagnostic signal and has a different amplitude, for example.

According to a further embodiment, the first input of the connection unit is connected to both the first and the second signal generator for feeding in the first and second diagnostic signal and the second input of the connection unit is connected to both the first and the second signal generator for feeding in the first and second diagnostic signal.

According to a further embodiment, the connection unit is configured, for the first functional test, in particular for the recording of the diagnostic data, to couple, preferably alternately, the first signal generator to the first input of the processing unit and the second signal generator to the second input of the processing unit or to couple the first signal generator to the second input of the processing unit and the second signal generator to the first input of the processing unit. In other words, for the first functional test, either the first signal component of the reception signal can be replaced with the first diagnostic signal and the second signal component of the reception signal can be replaced with the second diagnostic signal or the first signal component of the reception signal with the second diagnostic signal and the second signal component of the reception signal with the first diagnostic signal, preferably alternately, for the following signal processing. Due to this design of the optoelectronic receiver (and in particular due to the connection of the inputs of the connection unit to both the first and the second signal generator in each case) and due to the alternating coupling, the dynamic range and preferably the full dynamic range of the optoelectronic receiver can be covered or checked with a smaller number, for example half the number, of signal generator settings within one diagnostic run-through.

The connection unit can, for example, comprise a first multiplexer that comprises the following: a first input, which is connected to the first output of the pixel array for feeding in the first signal component of the reception signal (and/or the reference signal) of the pixel array, a second input, which is connected to the first signal generator for feeding in the first diagnostic signal, a third input, which is connected to the second signal generator for feeding in the second diagnostic signal, and an output for the output of the first diagnostic signal, the second diagnostic signal or the first signal component of the reception signal and/or the reference signal. The connection unit can further comprise a second multiplexer that comprises the following: a first input, which is connected to the second output of the pixel array for the feeding in of the second signal component of the reception signal (and/or the reference signal), a second input, which is connected to the first signal generator for the feeding in of the first diagnostic signal, a third input, which is connected to the second signal generator for the feeding in of the second diagnostic signal, and an output for the output of the first diagnostic signal, the second diagnostic signal or the second signal component of the reception signal and/or the reference signal, wherein the first multiplexer and the second multiplexer can be configured, for the first functional test, in particular for the recording of the diagnostic data, to output the first diagnostic signal and the second diagnostic signal simultaneously, wherein the first multiplexer can output the first diagnostic signal and the second multiplexer can output the second diagnostic signal or vice versa. Preferably, the first multiplexer and the second multiplexer alternate in the outputting of the first diagnostic signal and the second diagnostic signal. It is understood that the first and the second multiplexer can also comprise more than three inputs and more than one output. Furthermore, there can also be more than two multiplexers, for example three, four or more multiplexers.

According to a further embodiment, the first diagnostic signal and the second diagnostic signal define a differential diagnostic signal at the outputs of the connection unit and/or at the inputs of the processing unit with respect to or by the processing unit, wherein the differential diagnostic signal has a positive or a negative polarity depending on the coupling setting of the connection unit.

According to a further embodiment, the connection unit is configured to invert the polarity of the differential diagnostic signal and preferably to invert said polarity multiple times during the diagnostic run-through.

According to a further embodiment, the first and/or the second diagnostic signal is/are static or variable.

According to a further embodiment, the first and/or second signal generator is/are configured to change the amplitude of the first and/or second diagnostic signal during the diagnostic run-through. Preferably, the first and the second signal generator is/are configured to alternately change the amplitude of the first diagnostic signal and the amplitude of the second diagnostic signal during the diagnostic run-through, i.e. the one diagnostic signal is changed while the other remains constant for the time being in order to then be changed in the next round.

For example, the connection unit can allow the polarity of the fed-in differential diagnostic signal to be swapped by a switchover in the coupling to the first or second signal generator. In this way, in a single diagnostic run-through, the entire dynamic range of both polarities can be checked or covered with a smaller number of generated diagnostic signal values and, for example, with only half the number of generated diagnostic signal values. The signal generators, viewed on their own in each case, do not have to cover the entire differential range since the polarity swap or the polarity switch enables the checking of a diagnostic signal with an inverted polarity without the entire dynamic range of both polarities (in relation to each individual signal generator) having to be run through.

According to one embodiment, the first and/or second signal generator is/are configured to test the entire dynamic range of the optoelectronic receiver, preferably including single-ended saturation and/or ADC saturation, in the diagnostic run-through.

According to a further embodiment, the first and/or second signal generator is/are configured to use different slopes (in particular different increments) for changing the amplitude of the first and/or second diagnostic signal during the diagnostic run-through. In particular, a control may be present that controls the first and/or second signal generator such that the different slopes for changing the amplitude of the first and/or second diagnostic signal result. By selecting the start values and slopes, it can be made possible that one of the two signal generators does not have to be varied for the diagnostic run-through, which can simplify the diagnostic run-through.

According to a further embodiment, the processing unit comprises at least one amplifier, in particular a differential amplifier, for signal amplification. The amplifier can comprise a first input and a second input, wherein, for example, the first input of the amplifier can be connected to the output of the first multiplexer and the second input of the amplifier can be connected to the output of the second multiplexer. The amplifier can be a programmable differential amplifier, for example. The amplifier can be a programmable differential amplifier having a differential output. The amplifier can be configured to provide analog correlated double sampling (CDS), amplifier offset cancellation and/or pixel reset voltage subtraction.

According to a further embodiment, the processing unit comprises an analog-to-digital converter (ADC). The amplifier is preferably connected (directly or indirectly) at the output side to the analog-to-digital converter. For example, the connection unit comprising the two multiplexers, the amplifier and the analog-to-digital converter, can be connected in series. The analog-to-digital converter can, for example, comprise an analog-to-digital converter having a differential input.

The optoelectronic receiver can optionally comprise a programmable data preprocessing unit that is configured to process an output signal of the analog-to-digital converter of the optoelectronic receiver, and in particular to provide a normalization of different gain settings of the amplifier of the processing unit and/or a format conversion of the digital output signal of the analog-to-digital converter, and preferably to provide a format conversion of digital data based on the digital output signal of the analog-to-digital converter prior to transmission to a downstream data processing unit. It is understood that, by means of the procedures described herein and the design and the configuration of the optoelectronic receiver, errors in the data preprocessing unit can also be recognized during the operation of the optoelectronic receiver since, for example, differences between diagnostic data preprocessed incorrectly by the data preprocessing unit and diagnostic data preprocessed as expected can be detected.

According to a further embodiment, the processing unit further comprises at least one gain selection comparator that is connected to the amplifier and that is configured to compare the reception signal, the reference signal or the diagnostic signal, in particular the differential diagnostic signal, with at least one gain selection threshold value so that the gain of the amplifier can be selected based on an output signal of the gain selection comparator. The gain selection comparator can be a fully differential gain selection comparator. The selectable gain factors can be programmable. The number of gain selection comparators can depend on the gain factors available for selection and can scale with them. The at least one gain selection threshold value can be calibration-dependent and/or can be programmed (e.g. by a control). The at least one gain selection threshold value can, for example, be generated by means of at least one DAC.

For example, the processing unit can comprise at least a first and a second gain selection comparator (for example two fully differential gain selection comparators) that are connected to the amplifier and that are configured to compare the (differential) reception signal or the (differential) diagnostic signal (or also other signals such as the reference signal) with a first, in particular a negative, gain selection threshold value and a second, in particular a positive, gain selection threshold value so that the gain of the amplifier can be selected based on an output signal of the gain selection comparator. The absolute amounts of the first and second gain selection threshold value can be the same or different from one another. Preferably the amounts are the same. In other words, one gain selection comparator can be present for each polarity of a gain selection threshold value (or its magnitude). In this way, a falling below of the gain selection threshold value with a negative polarity and an exceeding of the gain selection threshold value with a positive polarity can be recognized in order to subsequently switch the gain factor. The signal components of the (differential) reception signal or the (differential) diagnostic signal can be interchangeably fed to the gain selection comparators, i.e. the first signal component of the reception signal or one of the diagnostic signals can be fed into one input of each gain selection comparator and the second signal component of the reception signal or the other diagnostic signal can be fed into another input of the gain selection comparator, or vice versa. In this way, the same gain selection threshold value can be used, in particular if the polarity of the differential diagnostic signal is swapped.

According to a further embodiment, the pixel array comprises a plurality of reception pixels, wherein the plurality of reception pixels are arranged in columns and/or rows. For example, the pixel array can have 512 or 1024 columns and 512 or 1024 rows of reception pixels. For example, for each (differential) reception pixel of the pixel array, there can in each case be a first output for the output of a first signal component of the reception signal (of the respective reception pixel) and in each case a second output for the output of a second signal component of the reception signal (of the respective reception pixel). Preferably, for each column and/or row of the pixel array, a first output is in each case present for the output of a first signal component of a (differential) reception signal (of the respective column or row) and a second output is in each case present for the output of a second signal component of the (differential) reception signal (of the respective column or row).

According to a further embodiment, in each case one connection unit and one processing unit are provided for each individual column and/or row of the pixel array. Alternatively, in each case one connection unit and one processing unit can be provided for a plurality of columns and/or rows taken together and/or only for certain columns and/or rows. In other words, the connection unit and the processing unit, and in particular the amplifier, can be shared by a plurality of columns and/or rows of the pixel array, which can allow an efficient utilization of the hardware components. The provision of in each case one connection unit and one processing unit only for certain columns and/or rows of the pixel array can allow only the real (live) measurement data generated by the certain columns and/or rows of the pixel array to be replaced with the diagnostic data in the first functional test. Preferably, columns and/or rows of the pixel array are selected for the first functional test that are (in any case) unsuitable for the distance measurement, i.e., for example, columns and/or rows at the edges of the pixel array that may not be sufficiently illuminated under certain circumstances. Furthermore, other test images or test data that serve to monitor other structures of the optoelectronic receiver can also be replaced with the diagnostic data, as already mentioned. Preferably, the diagnostic signal fed into the connection unit and/or processing unit of a column and/or row is changed during the readout of the column and/or row (by reprogramming the associated signal generator). Even more dynamic diagnostic data can thereby be obtained.

According to a further embodiment, the same diagnostic signal is used for a plurality of columns and/or rows. The use of the same diagnostic signal for a plurality of columns and/or rows can enable an averaging of a plurality of measurements (i.e. a plurality of columns and/or rows), which can reduce the noise prior to the data processing. Furthermore, the use of the same diagnostic signal for a plurality of rows and/or columns can be combined with the polarity swap described herein, e.g. for every second row of the pixel array. The use of the same diagnostic signal for a plurality of rows and/or columns can also be relevant if hardware resources, such as an amplifier, are shared between a plurality of columns of the pixel array and/or the image width of the test image is smaller than the number of columns.

According to a further embodiment, the pixel array comprises a plurality of reference pixels. The reference pixels are preferably arranged in columns and/or rows. Preferably, the plurality of reference pixels comprise a plurality of dark pixels and/or a plurality of reference reception pixels.

A further subject of the invention is an optoelectronic sensor, in particular an optoelectronic sensor for distance measurement by means of time-of-flight methods, preferably for use in an industrial plant and/or for safety applications, comprising at least one optoelectronic receiver described herein and at least one (in particular optoelectronic) light transmitter for transmitting transmission light.

The optoelectronic sensor is preferably a safety sensor. The optoelectronic sensor preferably comprises only one optoelectronic receiver.

The optoelectronic sensor can, for example, comprise a power supply.

The optoelectronic sensor can, for example, comprise a laser scanner or a camera system for distance measurement by means of time-of-flight methods.

The light transmitter can, for example, transmit at least one laser beam.

The light transmitter can be configured to transmit transmission light into a detection zone in an industrial plant. The transmission light can then be reflected and/or remitted by the detection zone, and in particular by objects in the detection zone, and can be received by the optoelectronic receiver as reception light reflected back to the optoelectronic receiver. Distance values of the objects (relative to the optoelectronic sensor) can then be determined based on the generated and output reception signal.

According to one embodiment, the optoelectronic sensor further comprises at least one reference illumination unit for transmitting reference light that is guided within the optoelectronic receiver onto the pixel array, in particular the at least one reception pixel. The reference light is preferably guided (directly) via a coupling element, in particular via at least one reflective region and/or a light guide, onto the pixel array, in particular the at least one reception pixel.

According to a further embodiment, the reference light is preferably modulated with the same modulation frequency as the transmission light transmitted by the light transmitter. Furthermore, the reference light can also match the transmission light transmitted by the light transmitter with respect to the duty cycle, the integration time and/or with respect to the phase offset for pixel modulation. In this way, the implementation of the aforementioned illumination characteristics can be checked by the optoelectronic receiver. In this respect, the phase position or the phase offset can refer to the time difference between illumination and scanning in the pixel.

According to a further embodiment, the pixel array is configured, for a fourth functional test, in particular for the recording of second reference data, to generate and output a second reference signal based on reference light received by means of the at least one reception pixel, and the connection unit is configured to couple the pixel array to the processing unit at (pre)determined time intervals in order to feed the second reference signal into the processing unit for signal processing for the fourth functional test, in particular for the recording of the second reference data. Advantageously, the reference illumination unit can be configured to transmit the reference light (only) for the fourth functional test, in particular for the recording of the second reference data, wherein the transmitted reference light is received by the at least one reception pixel (instead of the reflected/remitted transmission light) as reception light. Preferably, the connection unit is configured, for the fourth functional test, to couple the pixel array to the processing unit (at predetermined points in time) during each illumination phase of the distance measurement and/or between each illumination phase of the distance measurement. The connection unit is preferably configured, for the fourth functional test, to couple the pixel array to the processing unit at the same recording rate as the distance measurement. By means of this fourth functional test, errors in the optoelectronic receiver, and in particular both in the pixel array and in downstream components, such as the connection unit, the processing unit and/or the data preprocessing unit, can be recognized during the operation of the optoelectronic receiver and the functional safety of the optoelectronic receiver can be further improved. The reception pixels can possibly also be affected by external influences during the fourth functional test. It can therefore be checked by the fourth function check whether the optoelectronic sensor is also functional under external influences. Furthermore, it is conceivable that medium to high or even saturated signal amplitudes can also be tested in the fourth functional test (in particular by setting the reference light).

It is understood that the first, second, third and fourth functional test can also be implemented in any combination in the optoelectronic sensor. For example, the second, third and/or fourth functional test can be implemented in the optoelectronic sensor instead of the first functional test. Advantageously, the combination of a plurality of the functional tests, in particular all the functional tests, can allow the optoelectronic sensor, in particular the pixel array, the connection unit, the processing unit, the (optional) data preprocessing unit and (optional) further components, to be tested over the entire dynamic range and, as a result, the safety of the optoelectronic sensor to be improved even further.

According to a further embodiment, a plurality of data sets of second reference data are recorded between or during each illumination phase of the distance measurement.

According to a further embodiment, the pixel array and/or the reference illumination unit is/are configured to use different settings for each recording of a data set of second reference data, in particular different amplitudes for the reference light, different frequencies for the reference light, different phase positions for the reference light, different modulation frequencies for the reference light, and/or different integration times for the reading out of the reception pixel. Integration time is in particular to be understood as the duration in which a pixel receives light and the charge in the pixel can thereby change.

According to a further embodiment, the pixel array is configured, for the fourth functional test, to receive the reference light having at least a first reception pixel and at least a second reception pixel and, in so doing, to illuminate the first and second reception pixel with different illumination times and/or to read out said first and second reception pixel with different integration times for the generation and outputting of the second reference signal. Such an approach can also be referred to as an “interleaved high dynamic range mode” and allows even more “reference points” to be obtained, even if, for example, the pixel array, in particular the at least one reception pixel, is homogeneously illuminated with the reference light.

According to a further embodiment, the diagnostic data, the first reference data, the second reference data, the dark signal data and/or real measurement data are merged into at least one combined output image. It is likewise conceivable that, if applicable, the plurality of data sets of diagnostic data, the plurality of data sets of dark signal data, the plurality of data sets of first reference data and/or real measurement data can also be merged into at least one combined output image.

According to a further embodiment, the optoelectronic sensor further comprises a data processing unit that is configured to monitor the operating state of the optoelectronic sensor, in particular of the optoelectronic receiver, based on the (recorded) diagnostic data, based on the (recorded) first reference data, based on the (recorded) second reference data and/or based on the (recorded) dark signal data.

According to a further embodiment, the data processing unit is configured to monitor whether the diagnostic data, the dark signal data, the first reference data and/or the second reference data have a signal amplitude within a respective expected range. The monitoring of the signal amplitudes can provide a simpler evaluation basis for the recognition of errors. For example, it can be checked whether medium to high or even saturated signal amplitudes are recognizable in the recorded data. Alternatively or additionally, the data processing unit can be configured to monitor, by a statistical evaluation, which number of reception pixels, of dark pixels and/or of reference reception pixels output a signal amplitude within their respective expected range. Preferably, the respective expected range for the dark signal data, the first reference data and/or the second reference data excludes/exclude a saturation range (of the optoelectronic receiver). It is understood that the expected range for the diagnostic data, the dark signal data, the first reference data and the second reference data can be a different one in each case. The data processing unit can be configured to carry out the monitoring, in particular the statistical evaluation, based on a calculation and evaluation of a histogram, the standard deviation, the mean value, the median, etc., which can be particularly advantageous if the pixel array, in particular of the at least one reception pixel, is homogeneously illuminated with the reference light. Due to these procedures, the data processing unit can monitor the operating status of the optoelectronic sensor without having to perform complex arithmetic operations such as correlation, calculation of phase differences or calculation of distance values (in particular based on the second reference data). The data processing unit can be connected to the data preprocessing unit of the optoelectronic receiver to receive and further process preprocessed data.

According to a further embodiment, a warning signal is output if the diagnostic data, the dark signal data, the first reference data and/or the second reference data have a signal amplitude outside their respective expected range and/or if the number of reception pixels, dark pixels and/or reference reception pixels that output a signal amplitude outside their respective expected range is equal to or greater than a limit value.

A further subject of the invention is the use of an optoelectronic sensor described herein for distance measurement by means of time-of-flight methods.

A further subject of the invention is a method for monitoring the operation of an optoelectronic sensor described herein, in particular of an optoelectronic receiver described herein, comprising generating at least one diagnostic signal; outputting a reception signal generated based on received reception light and/or a reference signal generated by reading out at least one reference pixel; and selectively coupling the pixel array or the at least one signal generator to the processing unit so that selectively the reception signal and/or the reference signal, on the one hand, or the diagnostic signal, on the other hand, can be fed into the processing unit for signal processing, wherein the signal generator is coupled to the processing unit at determined time intervals in order to feed the diagnostic signal into the processing unit for signal processing for a first functional test, in particular for the recording of diagnostic data. The signal generator is preferably coupled to the processing unit (at predetermined points in time) during, in particular at the end of, each illumination phase of the distance measurement and/or between each illumination phase of the distance measurement. For the first functional test, the signal generator is preferably coupled to the processing unit at the same recording rate as the distance measurement.

It is understood that the operating state of the optoelectronic sensor, in particular of the optoelectronic receiver, can then be monitored based on the (recorded) diagnostic data, based on the (recorded) dark signal data, based on the (recorded) first reference data and/or based on the (recorded) second reference data. For example, a warning signal can be output in response to the recognition of an error.

It is understood that what has been described with respect to the optoelectronic receiver according to the invention also applies to the optoelectronic sensor, the use of the optoelectronic sensor and the method. This in particular applies to embodiments and advantages. Furthermore, it is to be understood that all the features and embodiments disclosed herein can be combined unless expressly stated otherwise.

The invention will be described below purely by way of example with reference to possible embodiments and to the enclosed drawing. There are shown:

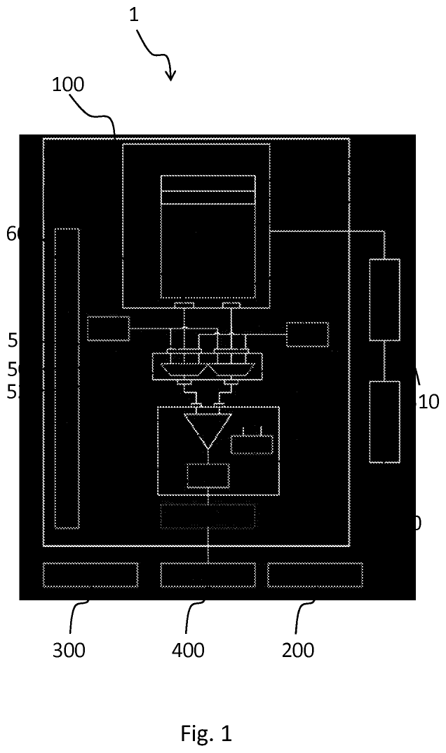

FIG. 1 a schematic representation of an optoelectronic sensor;

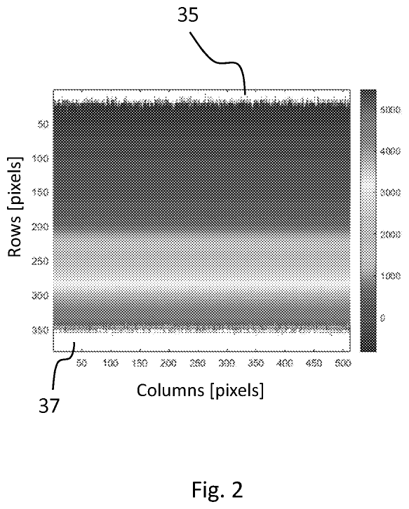

FIG. 2 a graphical representation of diagnostic data recorded by means of an optoelectronic sensor;

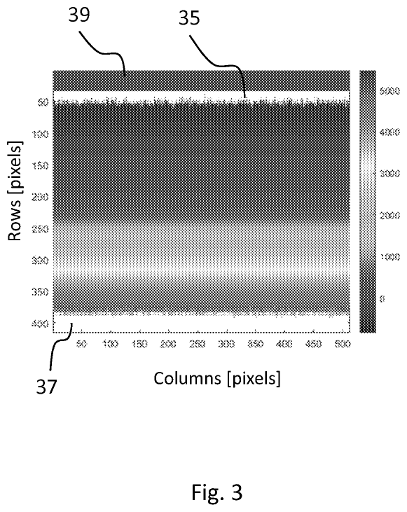

FIG. 3 a graphical representation of diagnostic data and dark signal data recorded by means of an optoelectronic sensor;

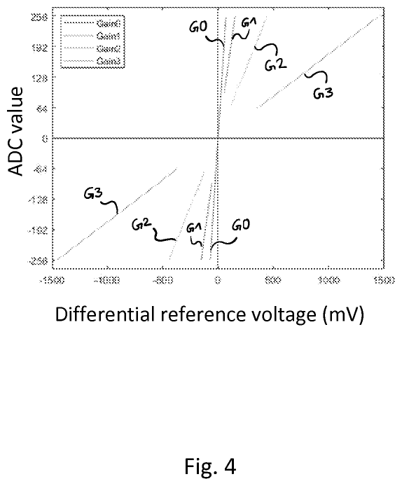

FIG. 4 a graphical representation of different gains; and

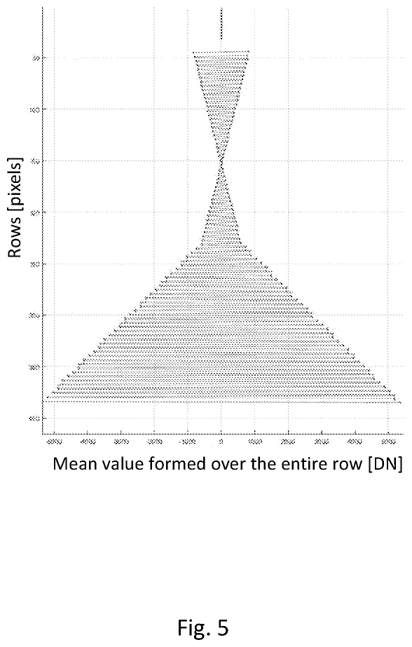

FIG. 5 a further graphical representation of the diagnostic data and dark signal data from FIG. 3.

The optoelectronic sensor 1 shown in FIG. 1, in particular for distance measurement by means of time-of-flight methods and preferably for use in an industrial plant and/or for safety applications, comprises an optoelectronic receiver 100, a light transmitter 200 for transmitting transmission light, a power supply 300, a data processing unit 400 and a reference illumination unit 500.

The light transmitter 200 in FIG. 1 is configured to transmit transmission light in pulses into a detection zone in an industrial plant. The transmission light transmitted by the light transmitter 200 can be reflected or remitted (i.e. diffusely reflected) by the detection zone, and in particular by objects in the detection zone, and can reach the optoelectronic receiver 100 as reception light.

The optoelectronic receiver 100, as shown in FIG. 1, comprises a first signal generator 10 for generating a first diagnostic signal A and a second signal generator 20 for generating a second diagnostic signal B. The signal generators 10, 20 comprise digital-to-analog converters (DAC) and are present and/or pre-installed for an initial (electrical) calibration of the optoelectronic sensor 1.

The optoelectronic receiver 100 in FIG. 1 further comprises a pixel array 30 that comprises a plurality of reception pixels 32, a plurality of reference reception pixels 34 and a plurality of dark pixels 36. The plurality of reception pixels 32 are arranged in n columns and m rows, the plurality of reference reception pixels 34 are arranged in n columns and r rows, and the plurality of dark pixels 36 are arranged in n columns and p rows. It is understood that other arrangements of the reception pixels, dark pixels and reference reception pixels are also possible. The pixel array 30 in FIG. 1 has 512 columns of reception pixels. The reference reception pixels 34 separate the reception pixels 32 and the dark pixels 36 from one another (see FIG. 1).

The pixel array 30 of the optoelectronic receiver 100 in FIG. 1 is configured to generate and output a differential reception signal based on the received reception light (per reception pixel). A distance measurement can take place by means of time-of-flight methods based on the differential reception signal.

The pixel array 30 (FIG. 1) is configured, for a second functional test, in particular for the recording of dark signal data 39 (FIG. 3), to generate and output a dark signal by reading out the dark pixels 36.

Alternatively or additionally, the pixel array 30 (FIG. 1) is configured, for a third functional test, in particular for the recording of first reference data, to generate and output a first reference signal by reading out the reference reception pixels 34.

The reference illumination unit 500 is configured to transmit reference light that is guided to the reception pixels 32 (and reference reception pixels 34) via a coupling element 510 within the optoelectronic sensor 1. The coupling element 510 can be at least one reflective region and/or a light guide. The reference light transmitted by the reference illumination unit 500 is modulated with the same modulation frequency as the transmission light transmitted by the light transmitter 200. The reference illumination unit 500 is configured to transmit the reference light (only) for a fourth functional test, in particular for the recording of second reference data, wherein the transmitted reference light is received by the reception pixels 32 (instead of the reflected/remitted transmission light) as reception light. The pixel array 30 is configured, for the fourth functional test, in particular for the recording of the second reference data, to generate and output a second reference signal based on reference light received by means of the reception pixels 32.

The reception signal output by the pixel array 30 comprises a first signal component and a second signal component in each case. The same applies to the dark signal, the first reference signal and the second reference signal. The design of the reception pixels and those pixels for the dark signal is preferably identical, for example, to obtain an identical aging or change. For each of the n columns, the pixel array 30 comprises a first output 31 for the output of the first signal components and a second output 33 (separate from the first output) for the output of the second signal components. In the optoelectronic receiver 100, in the optoelectronic sensor 1, a connection unit 50 and a processing unit 40 (not shown in FIG. 1) are provided for each of the n columns of the pixel array 30 so that each column of the pixel array 30 can be checked.

The optoelectronic receiver 100 in FIG. 1 further comprises at least one processing unit 40 for signal processing and at least one connection unit 50. As shown in FIG. 1, a first input 51 of the connection unit 50 is connected to the first output 31 of the pixel array 30, the first signal generator 10 and the second signal generator 20. A second input 53 of the connection unit 50 is connected to the second output 33 of the pixel array 30, the first signal generator 10 and the second signal generator 20. A first output 55 of the connection unit 50 is connected to a first input 41 of the processing unit 40. A second output 57 of the connection unit 50 is connected to the second input 43 of the processing unit 40.

The connection unit 50 in FIG. 1 is configured to selectively couple the first output 31 and the second output 33 of the pixel array 30 to the first input 41 and second input 43 of the processing unit 40, on the one hand, or, on the other hand, the first signal generator 10 and the second signal generator 20 to the first input 41 and the second input 43 of the processing unit 40 so that selectively the reception signal, the dark signal, the first reference signal and/or the second reference signal, on the one hand, or the first and second diagnostic signal A, B, on the other hand, can be fed into the processing unit 40 for signal processing. For this purpose, the connection unit 50 comprises a first multiplexer 52 and a second multiplexer 54. It is understood that there can also be more than two multiplexers, i.e., for example, also three, four or more multiplexers.

In other words, in a first coupling setting, the (differential) reception signal, the dark signal, the first reference signal and/or the second reference signal can be fed into the processing unit 40 for signal processing and, in contrast thereto, in another, second coupling setting, the first and second diagnostic signal A, B can be fed into the processing unit 40 for signal processing. In FIG. 1, the optoelectronic receiver 100 is shown in a second coupling setting during the recording of diagnostic data.

The connection unit 50 in FIG. 1 is configured to couple the first and second signal generator 10, 20 to the processing unit 40 (at predetermined points in time) during, in particular at the end of, each illumination phase of the distance measurement and/or between each illumination phase of the distance measurement, in order to feed the first and second diagnostic signal A, B into the processing unit 40 for signal processing for a first functional test, in particular for the recording of diagnostic data.

Alternatively or additionally, the connection unit 50 is configured to couple the pixel array 30 to the processing unit 40 (at predetermined points in time) during each illumination phase of the distance measurement and/or between each illumination phase of the distance measurement in order to feed the dark signal into the processing unit 40 for signal processing for the second functional test, in particular for the recording of the dark signal data.

Alternatively or additionally, the connection unit 50 is configured to couple the pixel array 30 to the processing unit 40 (at predetermined points in time) during each illumination phase of the distance measurement and/or between each illumination phase of the distance measurement in order to feed the first reference signal into the processing unit 40 for signal processing for the third functional test, in particular for the recording of the first reference data.

Alternatively or additionally, the connection unit 50 is configured to couple the pixel array 30 to the processing unit 40 (at predetermined points in time) during and/or between each illumination phase of the distance measurement in order to feed the second reference signal into the processing unit 40 for signal processing for the fourth functional test, in particular for the recording of the second reference data. In this respect, a plurality of data sets of second reference data are recorded between or during each illumination phase of the distance measurement. The pixel array 30 and the reference illumination unit 500 are configured to use different settings for each recording of a data set of second reference data, in particular different amplitudes for the reference light, different phase positions for the reference light, different modulation frequencies for the reference light, different integration times for the reception pixels 32. Alternatively or additionally, the pixel array 30 is configured, for the fourth functional test, to receive the reference light with at least a first row of the m rows of the plurality of reception pixels 32 and with at least a second row of the m rows of the plurality of reception pixels 32 and, in so doing, to apply different integration times for generating the second reference signal for the reception pixels 32 in the first and second row of the m rows of the reception pixels 32. The reading out therefore takes place row-wise so that values of reception pixels 32 from different rows (but the same columns) are processed in a circuit associated with one column in each case.

It is understood that the above example can also be swapped with respect to the columns and rows.

The first and/or second reference signal can, for example, be generated and evaluated as described in paragraphs [0025] to [0027] and [0030] to [0045] of EP 4 047 389 A1.

The optoelectronic receiver 100 in FIG. 1 further comprises a control 60, such as a microprocessor, a (simpler) programmable state machine, or a field programmable gate array (FPGA), that is configured to control the optoelectronic sensor 1 and in particular the optoelectronic receiver 100. The control 60 can, for example, be pre-installed in the optoelectronic receiver 100 to control general functions of the pixel array 30 and/or the processing unit 40. The control 60 can be configured to likewise control the connection unit 50, the light transmitter 200 and/or the reference illumination unit 500 to implement the functional tests of the optoelectronic receiver 100.

The first and second diagnostic signal A, B define a differential diagnostic signal (B-A or A-B depending on the coupling setting of the connection unit 50) at the outputs 55, 57 of the connection unit 50 and/or at the inputs 41, 43 of the processing unit 40 with respect to or by the processing unit 40. The differential diagnostic signal has a positive polarity if B-A or A-B is greater than zero and a negative polarity if B-A or A-B is less than zero. The absolute level of the first and second diagnostic signal A, B can be relevant for the recognition or testing of the saturation of in each case a single part of the differential measurement (“single-ended saturation”). For a test of both polarities, it is sufficient to control the connection unit 50 such that each of the two multiplexers 52, 54 uses the respective other signal generator 10, 20 as an input so that a reversal of the polarity can take place without one of the two signal generators 10, 20 having to be reconfigured.

The connection unit 50 (FIG. 1) is configured, for the first functional test, to alternately feed the first diagnostic signal A into the first input 41 of the processing unit 40 and the second diagnostic signal B into the second input 43 of the processing unit 40 or the first diagnostic signal A into the second input 43 of the processing unit 40 and the second diagnostic signal B into the first input 41 of the processing unit 40. In other words, the connection unit 50 is configured, for the first functional test, to invert the polarity of the fed-in differential diagnostic signal B-A, A-B. The first and the second diagnostic signal A, B are variable. The signal generators 10, 20 can be configured, for the first functional test, to alternately change the first and the second diagnostic signal A, B during a diagnostic run-through. For example, one of the two signal generators 10, 20 can change the amplitude of the diagnostic signal A, B generated by it, while the other of the two signal generators 10, 20 generates a constant diagnostic signal in order to then change the diagnostic signal A, B generated by it in the next round. The first and/or second signal generator 10, 20 is/are configured to use different slopes for changing the amplitude of the first and second diagnostic signal A, B during a diagnostic run-through. The first and/or second signal generator 10, 20 is/are consequently configured to change the amplitude of the first and/or second diagnostic signal A, B, and thus the amplitude and/or polarity of the differential diagnostic signal B-A, A-B, during a diagnostic run-through and accordingly to perform a voltage sweep of the differential diagnostic signal. In combination with the polarity swap, in one diagnostic run-through, the entire dynamic range of both polarities can be checked or covered with a smaller number of generated diagnostic signal values and, for example, with only half the number of generated diagnostic signal values. The signal generators 10, 20, viewed on their own in each case, do not have to cover the entire dynamic range since the polarity swap or the polarity switch enables the checking of a differential diagnostic signal with inverted polarity (e.g. B-A, A-B) without, for example, the differential diagnostic signal B-A having to pass through the entire dynamic range of both polarities.

The processing unit 40 of the optoelectronic receiver in FIG. 1 comprises at least one amplifier 42, in particular a differential amplifier, for signal amplification. The processing unit 40 in FIG. 1 further comprises a first and a second gain selection comparator 46, 48 that are connected to the amplifier 42 and that are configured to compare the (differential) reception signal, the dark signal, the first reference signal, the second reference signal or the diagnostic signal with a first, in particular negative, gain selection threshold value and with a second, in particular positive, gain selection threshold value in each case so that the gain of the amplifier 42 can be selected based on an output signal of the gain selection comparators 46, 48. The gain selection threshold values can be programmable and can, for example, be generated by means of a DAC in each case.

The processing unit 40 shown in FIG. 1 further comprises an analog-to-digital converter (ADC) 44, wherein the amplifier 42 is connected at the output side to the ADC 44. In other words, the connection unit 50 is connected in series with the two multiplexers 52, 54, the amplifier 42 and the ADC 44. The ADC 44 comprises an analog-to-digital converter having a differential input that supplies output data provided with a corresponding sign.

The optoelectronic receiver 100 in FIG. 1 comprises a (programmable) data preprocessing unit 70 that is configured to process a digital output signal of the ADC 44. The data preprocessing unit 70 is configured to provide a normalization of different gain settings of the amplifier 42 and/or a format conversion of a digital output signal of the ADC 44. The data preprocessing unit 70 is configured to provide a format conversion of digital data based on the digital output signal of the ADC 44 prior to transmission to the downstream data processing unit 400.

The data processing unit 400 of the optoelectronic sensor 1 (FIG. 1) is connected to the data preprocessing unit 70 of the optoelectronic receiver 100 in order to receive and further process a preprocessed signal.

The data processing unit 400 (FIG. 1) is configured to monitor the operating state of the optoelectronic sensor 1, in particular of the optoelectronic receiver 100, based on the (recorded) diagnostic data, based on the (recorded) first reference data, based on the (recorded) second reference data and/or based on the (recorded) dark signal data. The data processing unit 400 is configured to monitor whether the diagnostic data (FIGS. 2, 3 and 5), the dark signal data (FIGS. 3 and 5), the first reference data and/or the second reference data have a signal amplitude within a respective expected range. Alternatively or additionally, the data processing unit 400 is configured to monitor, by a statistical evaluation, which number of reception pixels 32, dark pixels 36 and/or reference reception pixels 34 output a signal amplitude within their respective expected range. The monitoring, in particular the statistical evaluation, takes place based on a calculation and evaluation of a histogram, the standard deviation, the mean value and/or the median. Using these procedures, the data processing unit 400 can monitor the operating status of the optoelectronic sensor without having to perform complex arithmetic operations such as correlation, calculation of phase differences or calculation of distance values (in particular using the second reference data). When the diagnostic data (FIGS. 2, 3 and 5), dark signal data (FIGS. 3 and 5), the first reference data and/or the second reference data have a signal amplitude outside their respective expected range and/or when the number of reception pixels 32, dark pixels 36 and/or reference reception pixels 34 have a signal amplitude outside their respective expected range that is equal to or greater than a (respective) threshold value, a warning signal can be output.

FIG. 2 and FIG. 3 each show a graphical representation of diagnostic data (FIGS. 2 and 3) and dark signal data 39 (FIG. 3) that were recorded by a similar or the same optoelectronic sensor 1 as shown in FIG. 1 during a first functional test (FIGS. 2 and 3) and a second functional test (FIG. 3). The graphical representations of the recorded data shown in FIG. 2 and FIG. 3 can also be referred to as test images. The picture elements in the test images that correspond to the diagnostic data (FIG. 2 and FIG. 3) are no longer related to the individual pixels of the pixel array 30 due to the disconnection of the outputs of the pixel array 30 by the connection unit 50 during the first functional test. The displayed data of the picture elements are produced by the generated diagnostic signals A, B and therefore solely by a targeted control of the signal generators 10, 20, the connection unit 50 as well as the processing unit 40 and the data preprocessing unit 70. The representation here is intended to clarify the course of the voltage ramp, wherein each picture element of the diagnostic data shown corresponds to a digital value that is output by the data preprocessing unit 70 and that is attributable to the differential diagnostic signal generated by the signal generators 10, 20.

For the first functional test, in particular the diagnostic run-through, a voltage sweep was generated by the signal generators 10, 20. For this purpose, the amplitude of the first diagnostic signal A, generated by a first signal generator 10, was changed with different slopes and, for every second row of the diagnostic data, the polarity was reversed by means of the connection unit 50, i.e., for each even-numbered row of the pixel array 30, the first diagnostic signal A generated by the first signal generator 10 was fed into the first input of the processing unit 40 (in particular the amplifier 42) and the second diagnostic signal B generated by a second signal generator 20 was fed into the second input of the processing unit 40 (in particular the amplifier 42). To generate the diagnostic data for the odd-numbered rows, the second diagnostic signal B generated by the second signal generator 20 was accordingly fed into the first input 41 of the processing unit 40 (in particular of the amplifier 42) and the first diagnostic signal A generated by the first signal generator 10 was fed into the second input 43 of the processing unit 40 (in particular of the amplifier 42). By selecting the start values and slopes, as shown here, it can be made possible that the second diagnostic signal B output by the second signal generator 20 does not have to be varied, which further simplifies the voltage sweep. In the graphical representations of the diagnostic data shown in FIG. 2 and FIG. 3, the polarity change has been corrected for a simplified visualization so that the course of the resulting processed differential diagnostic signals is shown. As characterized in FIG. 2 and FIG. 3, the lower rows 35 of the pixel array 30 (in the range of less than 40 or 70 pixels) are in a so-called single-ended saturation, i.e. the amplitude of the diagnostic signals A and/or B corresponds to a saturation of a storage element of the respective (differential) reception pixel. It can be seen that the single-ended saturation is achieved at different amplitudes due to the tolerances of the individual processing units 40. Since it is possible to define regions in which saturation must be present or may no longer be present, it can be checked by means of these diagnostic data 35 whether the recognition of the single-ended saturation is possible and, from this, it can be concluded whether this recognition still works correctly during the recording of (live) measurement data, i.e. it can be recognized whether one of the two signal components of the differential reception signal or one of the storage elements of the (differential) reception pixel is in saturation, so that no measurement is possible. Due to the polarity changes also performed for this data range, the recognition of the single-ended saturation can be tested for both signal components and thus completely. The upper rows 37 of the pixel array 30 (in the range of more than 340 pixels or 360 pixels) correspond to a saturation of the ADC, i.e. a (differential) signal is present that is too low or too high. The signal components A and B can, for example, be so far apart that the ADC goes into saturation. The dark signal data 39 (FIG. 3) recorded during the second functional test by reading out the dark pixels 36 have been added to the diagnostic data to generate the combined test image shown in FIG. 3. For the recording of the data shown in FIGS. 2 and 3, the second functional test and the first functional test were performed in this order during an illumination phase of the distance measurement. An error of the optoelectronic receiver 100 can be recognized based on the diagnostic data 35, 37 and/or dark signal data 39, for example, in that changes in the data are recognized compared to the normal state, i.e., for example, changes in the signal amplitude that is expected and/or permissible for the respective row of the (combined) test pattern, or saturation information that is expected or permissible in dependence on the row of the (combined) test pattern. In response to the recognition of an error in the (combined) test image, a warning signal can, for example, be output by (the optoelectronic sensor 1).

FIG. 4 shows a graphical representation of different gains G0 to G3 (or Gain0 to Gain3) with an amplifier 42 of an optoelectronic receiver 100, such as is shown in FIG. 1, and illustrates the influence of the gains (or gain settings) on the digital output values of the ADC 44. The two diagnostic signals A and B generated by the two signal generators 10, 20 are voltage signals and are output by the amplifier 42 as a differential diagnostic voltage that is subsequently converted into the digital by the ADC 44. As shown in FIG. 4, a better coverage of the entire dynamic range of the amplifier 42 and the ADC 44 can be achieved for small signal amplitudes, i.e. necessarily also high gains (e.g. G0), by using a finer increment for the differential diagnostic voltage generated by the signal generators 10, 20, whereas a larger increment for the differential diagnostic voltage generated is sufficient for lower gains (e.g. G3). The selection of a smaller increment for small signal amplitudes results in a larger number of different diagnostic voltages (and thus test points) that can be used for the first functional test of the processing unit 40.

FIG. 5 shows a further graphical representation of the diagnostic data from FIG. 3. More precisely, FIG. 5 shows the average values, which are formed row-wise (considering the polarity), of the diagnostic data in FIG. 3 and illustrates the different slopes or the increments in the diagnostic signals for the diagnostic run-through. The data of a plurality of rows of dark signal data (up to row 32) can be seen at the upper edge, followed by a section with rows (approximately rows 32-40) in which both signal components are present alternately (due to the continuous polarity change) in single-ended saturation, followed by a voltage sweep with different slopes with a continuous polarity change by the connection unit 50 during a voltage sweep by only one of the two signal generators 10, 20 with a final occurrence of ADC saturation for both polarities of the differential diagnostic signal at the lower end of the (combined) test image (from approximately row 380).

### REFERENCE NUMERAL LIST

1 optoelectronic sensor
10 first signal generator
20 second signal generator
30 pixel array
31 first output of the pixel array
32 reception pixels
33 second output of the pixel array
34 reference reception pixels
35 rows of the test image in single-ended saturation
36 dark pixels
37 rows of the test image in ADC saturation
39 dark signal data
40 processing unit
41 first input of the processing unit
42 amplifier
43 second input of the processing unit
44 analog-to-digital converter
46 first gain selection comparator
48 second gain selection comparator
50 connection unit
51 first input of the connection unit
52 first multiplexer
53 second input of the connection unit
54 second multiplexer
55 first output of the connection unit
57 second output of the connection unit
60 control
70 data preprocessing unit
100 optoelectronic receiver
200 light transmitter
300 power supply
400 data processing unit
500 reference illumination unit
510 coupling element

1. An optoelectronic receiver, comprising at least one signal generator for generating at least one diagnostic signal;
a pixel array having at least one reception pixel and at least one reference pixel, wherein the pixel array is configured to generate and output a reception signal based on reception light received by means of the reception pixel and/or to generate and output a reference signal by reading out the reference pixel;
at least one processing unit for signal processing; and
at least one connection unit that is connected to the pixel array, the signal generator and the processing unit and that is configured to selectively couple the pixel array or the signal generator to the processing unit so that selectively the reception signal and/or the reference signal, on the one hand, or the diagnostic signal, on the other hand, can be fed into the processing unit for signal processing,
wherein the connection unit is configured to couple the signal generator to the processing unit at determined time intervals in order to feed the diagnostic signal into the processing unit for signal processing for a first functional test.

2. The optoelectronic receiver according to claim 1,
wherein the at least one reference pixel comprises at least one dark pixel, wherein the pixel array is configured, for a second functional test to generate and output a dark signal by reading out the dark pixel, and wherein the connection unit is configured to couple the pixel array to the processing unit at determined time intervals in order to feed the dark signal into the processing unit for signal processing for the second functional test; and/or
wherein the at least one reference pixel comprises at least one reference reception pixel that receives reference light and/or separates the at least one reception signal and at least one dark pixel of the pixel array from one another, wherein the pixel array is configured, for a third functional test to generate and output a first reference signal by reading out the reference reception pixel, wherein the connection unit is configured to couple the pixel array to the processing unit at determined time intervals in order to feed the first reference signal into the processing unit for signal processing for the third functional test.

3. The optoelectronic receiver according to claim 1, wherein the components of the optoelectronic receiver are pre-installed for a calibration of the optoelectronic receiver.

4. The optoelectronic receiver according to claim 1, wherein the diagnostic signal is static or variable.

5. The optoelectronic sensor according to claim 1,
wherein test data generated during a monitoring of at least one other component of the optoelectronic receiver are replaced with the diagnostic data;
wherein the diagnostic data and the dark signal data, the first reference data and/or real measurement data are merged into at least one combined output image.

6. The optoelectronic sensor according to claim 1,
wherein the pixel array comprises a first output for the output of a first signal component of the reception signal and a second output for the output of a second signal component of the reception signal, wherein a first input of the connection unit is connected to the first output of the pixel array and a second input of the connection unit is connected to the second output of the pixel array,
wherein the optoelectronic receiver comprises a first signal generator for generating a first diagnostic signal and a second signal generator for generating a second diagnostic signal,
wherein the connection unit is connected to the first output of the pixel array, the second output of the pixel array, the first signal generator, the second signal generator, a first input of the processing unit and a second input of the processing unit and is configured to selectively couple the first and second output of the pixel array to the first and second input of the processing unit or to couple the first and second signal generator to the first and second input of the processing unit.

7. The optoelectronic sensor according to claim 6,
wherein the first input of the connection unit is connected to the first and the second signal generator,
wherein the second input of the connection unit is connected to the first and the second signal generator,
wherein the connection unit is configured, for the first functional test to couple the first signal generator to the first input of the processing unit and the second signal generator to the second input of the processing unit or to couple the first signal generator to the second input of the processing unit and the second signal generator to the first input of the processing unit.

8. The optoelectronic sensor according to claim 6,
wherein the first diagnostic signal and the second diagnostic signal define a differential diagnostic signal at the outputs of the connection unit and/or at the inputs of the processing unit with respect to or by the processing unit, wherein the differential diagnostic signal has a positive or a negative polarity depending on the coupling setting of the connection unit; and/or
wherein the first and/or the second diagnostic signal is/are static or variable.

9. The optoelectronic sensor according to claim 1,
wherein the processing unit comprises at least one amplifier for signal amplification; and/or
wherein the processing unit comprises an analog-to-digital converter.

10. The optoelectronic sensor according to claim 1,
wherein the pixel array comprises a plurality of reception signals, wherein the plurality of reception signals are arranged in columns and/or rows; and/or
wherein the pixel array comprises a plurality of reference pixels.

11. An optoelectronic sensor, the optoelectronic sensor comprising at least one optoelectronic receiver according to claim 1 and at least one light transmitter for transmitting transmission light.

12. The optoelectronic sensor according to claim 11,
further comprising at least one reference illumination unit for transmitting reference light that is guided within the optoelectronic receiver onto the pixel array, wherein the reference light is guided to the pixel array, and
wherein the pixel array is configured, for a fourth functional test to generate and output a second reference signal based on reference light received by means of the at least one reception signal, and
wherein the connection unit is configured to couple the pixel array to the processing unit at determined time intervals in order to feed the second reference signal into the processing unit for signal processing for the fourth functional test.

13. The optoelectronic sensor according to claim 11,
wherein the diagnostic data, the first reference data, the second reference data, the dark signal data and/or real measurement data are merged into at least one combined output image; and/or
further comprising a data processing unit that is configured to monitor the operating state of the optoelectronic sensor, based on the diagnostic data, based on the first reference data, based on the second reference data and/or based on the dark signal data.

14. Method of using an optoelectronic sensor according to claim 11 for distance measurement by means of time-of-flight methods.

15. A method for monitoring the operation of an optoelectronic sensor according to claim 11, the method comprising
generating at least one diagnostic signal;
outputting a reception signal generated based on received reception light and/or a reference signal generated by reading out at least one reference pixel; and
selectively coupling the pixel array or the at least one signal generator to the processing unit so that selectively the reception signal and/or the reference signal, on the one hand, or the diagnostic signal, on the other hand, can be fed into the processing unit for signal processing, wherein the signal generator is coupled to the processing unit at determined time intervals in order to feed the diagnostic signal into the processing unit for signal processing for a first functional test.

16. The optoelectronic receiver according to claim 1, wherein the at least one reception pixel is a differential reception pixel (32).

17. The optoelectronic receiver according to claim 1, wherein the at least one reference pixel is a differential reference pixel.

18. The optoelectronic receiver according to claim 1, wherein the connection unit is configured to couple the signal generator to the processing unit at determined time intervals, and during each illumination phase of the distance measurement and/or between each illumination phase of the distance measurement, in order to feed the diagnostic signal into the processing unit for signal processing for a first functional test.

19. The optoelectronic receiver according to claim 1, wherein the connection unit is configured to couple the signal generator to the processing unit at determined time intervals, and during each illumination phase at the end of the distance measurement and/or between each illumination phase of the distance measurement, in order to feed the diagnostic signal into the processing unit for signal processing for a first functional test.

20. The optoelectronic receiver according to claim 1, wherein the connection unit is configured to couple the signal generator to the processing unit for the recording of diagnostic data.
